(19) United States
(12) Patent Application Publication
(10) Pub. No.: US 2022/0197481 A1
(43) Pub. Date: Jun. 23, 2022

(54) SYSTEM AND METHOD FOR REAL-TIME JURY SELECTION ANALYSIS AND TRACKING

(71) Applicant: Empirical Jury LLC, Greenwood Village, CO (US)

(72) Inventors: Alicia Campbell, Greenwood Village, CO (US); John Campbell, Greenwood Village, CO (US); Toby Garret Traylor, New Braunfels, TX (US); Sheryl Martin Traylor, New Braunfels, TX (US)

(21) Appl. No.: 17/167,557

(22) Filed: Feb. 4, 2021

Related U.S. Application Data
(60) Provisional application No. 63/129,302, filed on Dec. 22, 2020.

(51) Int. Cl. G06F 3/0481; G06Q 50/18; G06Q 10/10; G06F 3/0482; G06F 3/0484

(52) U.S. Cl. CPC G06F 3/04817; G06Q 50/18; G06F 3/04847; G06F 3/0482; G06F 3/04845; G06Q 10/10

(57) ABSTRACT

A system and method for juror selection tracking and analysis in a juror-tracking app interface. The method can include displaying on an electronic device's display screen a bounded area and selectable juror icons positioned therein, representing a courtroom and prospective jurors therein, respectively. The juror icons can be selectable, rotatable, and relocatable within the bounded area to mimic the courtroom configuration. The juror-tracking app interface can also display questions and corresponding selectable answers to track answers given by each of the prospective jurors. Points associated with each of the selectable answers can also be added to a running total of points for each of the prospective jurors displayed on a juror list or otherwise associated with the juror icons. Statuses of the prospective jurors (such as request or grant of a peremptory strike) can be selected from a menu and graphically displayed onto each of the corresponding juror icons.

### CROSS-REFERENCE TO RELATED APPLICATIONS

This non-provisional patent application claims priority benefit of U.S. Provisional Patent App. No. 63/129,302, entitled “System and Method for Real-Time Jury Selection Analysis and Tracking,” filed Dec. 22, 2020, and incorporated by reference herein in its entirety.

### BACKGROUND

Jury selection for jury trials in United States courts is generally accomplished through a process called voir dire. Voir dire is a preliminary examination of a witness or a prospective juror by a judge and/or counsel. Various questions asked of each prospective juror can provide clues to counsel for each side of a case (e.g., the plaintiff and the defendant) regarding whether the prospective juror would likely rule favorably or unfavorably toward their client if seated on the jury. Tracking these answers and weighing their respective values overall for each prospective juror can be challenging. It is possible to have 100 potential jurors participating in voir dire. Individual prospective jurors and their answers to questions can be tracked using pen and paper or a computer spreadsheet, but these and other existing solutions generally have clumsy interfaces and do not allow for collaboration among a group of attorneys and legal staff during voir dire.

### SUMMARY

Embodiments of the present disclosure relate to systems and methods for real-time jury selection analysis and tracking. More specifically, embodiments relate to systems and methods for visually identifying various potential jurors in a courtroom, inputting their answers to questions in real time, and tracking other aspects of voir dire (e.g., peremptory and for-cause strikes) in a collaborative manner with various attorneys and legal staff. In essence, the described embodiments facilitate the ability to track in real time prospective juror answers to various questions and analyze how such answers affect their fitness and desirability as a juror for a particular side of the case.

In some example embodiments, a computer-implemented method for collecting and tracking jury selection analytics includes displaying on a display screen of an electronic device a bounded area representing a courtroom and selectable juror icons within the bounded area. The selectable juror icons represent one or more prospective jurors in the courtroom, and orientations of each of the selectable juror icons represent directions that the prospective jurors in the courtroom are facing, while locations of each of the selectable juror icons within the bounded area represent corresponding locations of the prospective jurors in the courtroom. Furthermore, the method may include receiving a selection of a first one of the selectable juror icons, and then changing, in response to receiving the selection, a visual characteristic (e.g., change of color, line thickness, etc.) of the first one of the selectable juror icons, indicating that the first one of the selectable juror icons is selected.

The method may further include receiving instructions to rotate the first one of the selectable juror icons and/or relocate the first one of the selectable juror icons and then rotating and/or relocating the first one of the selectable juror icons in response to the instructions. In some embodiments, the method may also include receiving information regarding the first one of the prospective jurors in the courtroom while the first one of the selectable juror icons remains selected and displaying on the display screen the information regarding the first one of the prospective jurors in the courtroom each time the first one of the selectable juror icons is selected. The information about the first one of the prospective jurors or any of the prospective jurors can be displayed in list form, in an adjacent area or pop-up window on the display screen, and/or via changes to visual characteristics of the juror icons.

In some embodiments, the methods herein can further comprise displaying juror questions and corresponding selectable answers. Each of the selectable answers can be associated with a predetermined point value which can be added to a cumulative point total for each of the prospective jurors and/or their associated juror icon. The cumulative point total can allow for analysis of whether or not striking a particular potential juror is desirable to one side or another in a jury trial. The method can also include visual indicators regarding a prospective juror's status, such as whether a peremptory strike or a for cause strike was requested and/or was granted.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present disclosure are described in detail below with reference to the attached drawing figures, wherein:

FIG. 1A depicts an exemplary operating environment in accordance with some embodiments of the present disclosure;

FIG. 1B is a block diagram illustrating an exemplary implementation of a system for juror selection in accordance with some embodiments of the present disclosure;

FIG. 2 is an exemplary juror-tracking app interface to be displayed on a display screen in accordance with some embodiments of the present disclosure;

FIG. 3 is the juror-tracking app interface of FIG. 2 with juror icons added to a bounded area representing a courtroom in accordance with some embodiments of the present disclosure;

FIG. 4 is the juror-tracking app interface of FIG. 3 with juror icons added, relocated, and reoriented in accordance with some embodiments of the present disclosure;

FIG. 5 is an exemplary pop-up window for creating or editing questions and answers to be displayed in the juror-tracking app interface of FIG. 2 in accordance with some embodiments of the present disclosure;

FIG. 6 is the juror-tracking app interface of FIG. 4 with juror 6 of a juror list selected in accordance with some embodiments of the present disclosure;

FIG. 7 is the juror-tracking app interface of FIG. 6 with a selectable answer highlighted as being selected for juror 6 in accordance with some embodiments of the present disclosure;

FIG. 8 is the juror-tracking app interface of FIG. 6 with the selectable answer “some” selected, none of the juror icons selected, and the selectable answer “lots” indicated in another pattern or color also applied to juror 6 and a corresponding one of the juror icons in accordance with some embodiments of the present disclosure;

FIG. 9 is the juror-tracking app interface of FIG. 8 with the selectable answer “some” selected and a plurality of the juror icons selected to correspond with the answer “some” in accordance with some embodiments of the present disclosure;

FIG. 10 is the juror-tracking app interface of FIG. 2, depicting a plurality of juror scores in the juror list based on juror answers to various questions in accordance with some embodiments of the present disclosure;

FIG. 11 is the juror-tracking app interface of FIG. 2, depicting a drop-down menu in a juror status box for selecting a prospective juror's status in accordance with some embodiments of the present disclosure;

FIG. 12a is the juror-tracking app interface of FIG. 11, depicting visual changes to the juror icons based on selection of the prospective juror's status in the juror status box in accordance with some embodiments of the present disclosure;

FIG. 12b is the juror-tracking app interface of FIG. 12a, depicting a comment/chat tab selected and a comment panel displayed as a result in accordance with some embodiments of the present disclosure;

FIG. 13 is the juror-tracking app interface of FIG. 12a, depicting visual changes to the juror icons following status selections for a plurality of the prospective jurors and with the juror status box hidden upon deselection of all of the juror icons in accordance with some embodiments of the present disclosure;

FIG. 14 is a flow diagram depicting a method for juror selection analysis and tracking in accordance with some embodiments of the present disclosure; and

FIG. 15 is a block diagram of an exemplary computing environment suitable for use in implementing some embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

During voir dire, various questions asked of each prospective juror can provide clues to counsel for each side of a case (e.g., the plaintiff and the defendant) regarding whether the juror would likely rule favorably or unfavorably toward their client. Tracking these answers and weighing their respective values can be challenging given the large number of prospective jurors. Information about individual jurors and answers to specific questions can be tracked using pen and paper or a computer spreadsheet, but these and other existing solutions generally have clumsy interfaces and do not allow for collaboration among a group of attorneys and legal staff during voir dire nor rapid entry and rapid review of various questions and juror answers. Furthermore, current methods of recalling which juror is sitting in which location are inadequate for efficiently accounting for the variety of courtroom setups with various shapes, sizes, seating configurations, and various directions in which the prospective jurors are facing. Specifically, traditional solutions only allow a two-dimensional, non-directional grid for placement and identification of jurors.

As such, various embodiments of the present disclosure are directed to a system and computer-implemented method for real-time juror selection analysis and tracking. More specifically, embodiments relate to systems and methods for assisting in visually identifying various potential jurors in a courtroom, logging answers to questions in real time, and tracking other aspects of voir dire (e.g., peremptory and for-cause strikes) in a collaborative manner with various attorneys and legal staff. Embodiments herein also provide for rapid entry of answers that an individual prospective juror supplied to multiple questions and the review of this information, as well as the selection of a question and rapid assignment of answers to those questions to potential jurors and the ability to review this information by selecting a question. Additionally, some embodiments herein allow for real time communication about the prospective jurors with free form commentary. Furthermore, embodiments of the present invention provide systems and methods for selectably defining point values for answers to various questions and for tallying those point values continuously in real time to assist a legal team in voir dire strategy. In essence, the described embodiments facilitate the ability to track in real time prospective juror answers to various questions and analyze how such answers affect their fitness and desirability as a juror for a particular side of the case.

In some example embodiments, a computer-implemented method for collecting jury selection analytics is implemented on a display screen of an electronic device and includes displaying a bounded area representing a courtroom and selectable juror icons within the bounded area. The selectable juror icons represent jurors in the courtroom, orientations of each of the selectable juror icons represent directions that the prospective jurors in the courtroom are facing, and locations of each of the selectable juror icons within the bounded area represent corresponding locations of the prospective jurors in the courtroom. Receiving selections of one of the selectable juror icons can be indicated by changing a visual characteristic of the juror icons. When selected, any of the juror icons can be rotated or relocated via commands received from the user, thereby providing an accurate visual of the potential jurors and their respective locations within the courtroom. The computer-implemented methods described herein can also include receiving information regarding the prospective jurors in the courtroom and associating that information with a corresponding selected one of the juror icons. Recorded information about each of the prospective jurors may be displayed each time a corresponding one of the juror icons is selected.

In some embodiments, information about each of the prospective jurors may be provided in a list on the screen, including their juror number, name, and other various information about the juror. When any of the juror names or numbers in the list are selected by a user (e.g., via a touch gesture, tap, click, etc.), the visual characteristic of a corresponding one of the juror icons may be changed to indicate that selection and additional information regarding that juror (such as answers to specific questions asked) can be displayed. For questions that have not yet been asked, a user can select a given answer for a particular juror while a corresponding one of the juror icons, names, and/or numbers currently remain selected. In addition to selecting individual answers for individual prospective jurors, all of the prospective jurors can be deselected (e.g., tapping or clicking on a selected one of the juror icons or an area of the screen where there is no juror icon) and a particular answer to a particular question can be selected. Then, any number of jurors providing that answer may be selected, thus efficiently assigning that one answer to multiple jurors in a short amount of time. This can be useful in situations where a question is asked of all of the prospective jurors and answers are provided simultaneously by a show of hands.

In some embodiments, other information can be recorded for various ones of the prospective jurors, such as a general sentiment about whether a particular juror would be favorable or unfavorable for a particular side in a case. For example, a sentiment slider associated with each juror icon can be provided (continuously or in response to selection of that juror icon) and can be adjusted by sliding or swiping a control icon thereof toward one end or another end of a visual line or channel to indicate sentiment toward that juror. This can be useful in situations where a prospective juror's demeanor or facial expressions or other characteristics cannot be easily captured through the logging of question answers alone.

In some embodiments, selectable status indicators can be displayed for each of the prospective jurors when their corresponding juror icons are selected. These selectable status indicators can visually indicate at least one of the following was requested or has been granted by a judge of the courtroom in regards to a corresponding one of the prospective jurors: a peremptory strike, a for cause strike, excused by the court, and selected for jury. Furthermore, the computer-implemented method described herein can include visually indicating on corresponding ones of the juror icons these requested or granted jury selection statuses for corresponding ones of the prospective jurors in the courtroom. Visually indicating these statuses on the juror icons may include adding a strike-out symbol over a graphical depiction of the juror or the like. Furthermore, such a visual indication of the jury selection status for various juror icons can selectably include a visual indication of which side of a case requested, for example, the peremptory strike or the for cause strike.

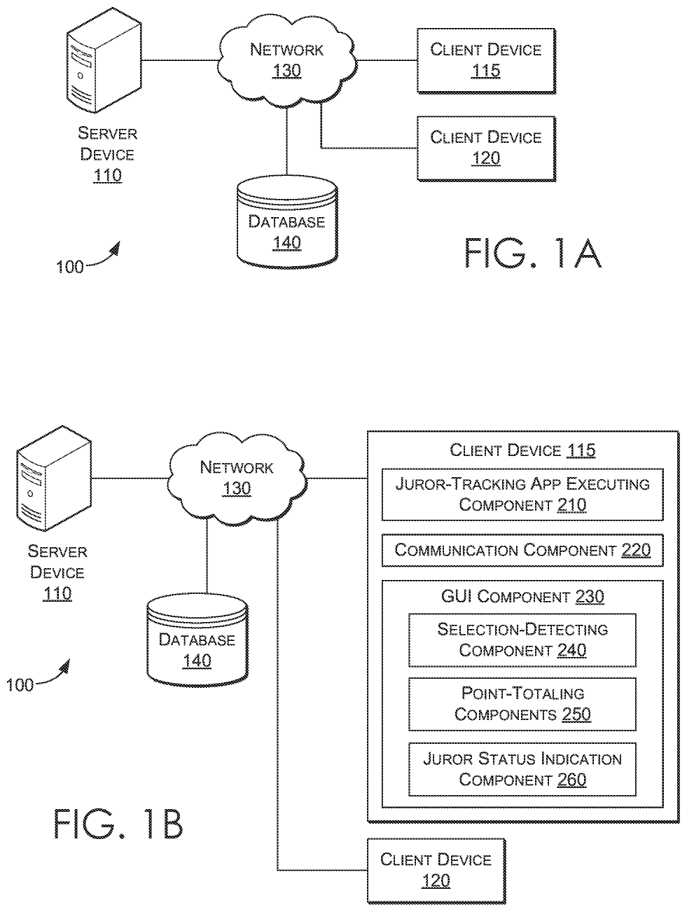

Turning now to FIG. 1A, a schematic depiction is provided illustrating one exemplary operating environment 100 of which an embodiment of the present disclosure can be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The operating environment 100 of FIG. 1A includes a server device 110 that provides a service to one or more client devices 115,120 for tracking and analyzing prospective jurors collaboratively in real time via an interactive visual interface environment over a network 130, such as the Internet. The client devices 115,120 may be implemented on one or more processors as later described herein. In some embodiments, the client devices 115,120 are mobile electronic devices having touchscreens thereon, such as smart phones, tablets, or laptop computers. The server device 110 and the client devices 115,120 may communicate in a wired or wireless manner over the network 130.

In some embodiments, the server device 110 is coupled, directly or indirectly, to a database 140 for facilitating the storage and querying of records corresponding to a plurality of instructions, actions, objects (e.g., juror icons), other selectable data (e.g., questions, answers, assigned points associated with various answers), and/or settings. The database 140 includes, among other things, a relational database or similar storage structure accessible by the server device 110. In accordance with embodiments described herein, the database 140 stores a plurality of records that each corresponds to instructions, actions, objects, other selectable data, and/or settings.

The server device 110 includes a server accessible by any of the client devices 115,120 and/or a data server for supporting an application of any of the client devices 115,120, over the network 130. The server can support any type of application, including those that facilitate live tracking and analyzing of prospective jurors collaboratively. The server device 110 can further determine relationships (e.g., co-counsel or other members of a legal team on a particular case) between the client devices 115,120. In various embodiments, the server device 110 communicates actions commanded via one or more of the client devices 115,120, to another one or more of the client devices 115,120 for presentation thereon via user interfaces or the like, as later described herein.

Network 130 may be wired, wireless, or both. Network 130 may include multiple networks, or a network of networks, but is shown in simple form so as not to obscure aspects of the present disclosure. By way of example, network 130 can include one or more wide area networks (WANs), one or more local area networks (LANs), one or more public networks, such as the Internet, one or more private networks, and/or one or more telecommunications networks. Where network 130 includes a wireless telecommunications network, components such as a base station, a communications tower, or even access points (as well as other components) may provide wireless connectivity. Networking environments are commonplace in enterprise-wide computer networks, intranets, and the Internet. Accordingly, network 130 is not described in significant detail.

In accordance with embodiments of the present disclosure, the server device 110 or the client devices 115, 120 can each be a computing device that is capable of accessing the Internet, such as the World Wide Web, and/or a telecommunications network. Any one of the server device 110 or the client devices 115, 120 might take on a variety of forms, such as a personal computer (PC), a laptop computer, a mobile phone, a tablet computer, a wearable computer, a personal digital assistant (PDA), an MP3 player, a global positioning system (GPS) device, a video player, a handheld communications device, a smartphone, a smart watch, a workstation, any combination of these delineated devices, or any other suitable device.

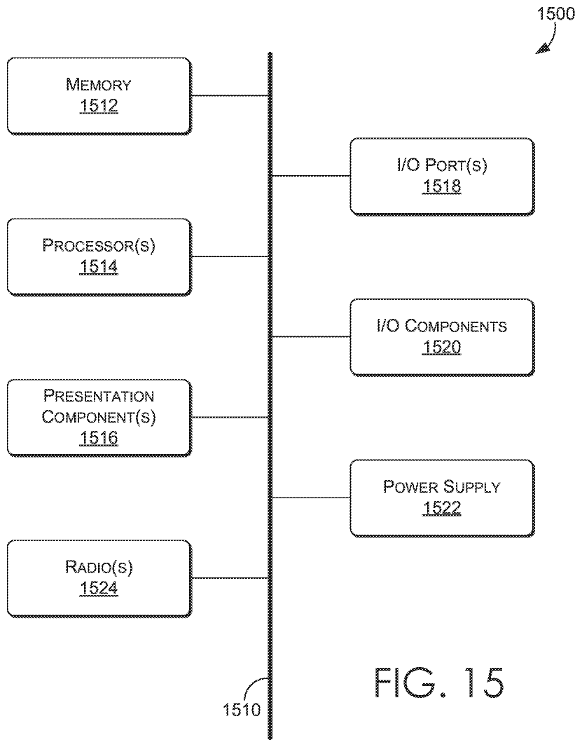

It should be understood that any number of the aforementioned devices may be employed in operating environment 100 within the scope of the present disclosure. Each may comprise a single device or multiple devices cooperating in a distributed environment. Additionally, other components not shown may also be included within the distributed environment. It should further be understood that operating environment 100 shown in FIG. 1A is an example of one suitable computing system architecture. Each of the servers, client devices, networks, and databases shown in FIG. 1A may be implemented via a computing device, such as computing device 1500, later described with reference for FIG. 15, for example. The components may communicate with each other via network 130.

Next, FIG. 1B depicts a block diagram of operational modules of an exemplary one of the client devices, specifically client device 115, in accordance with some embodiments of the present disclosure. It is noted that the depicted implementation is merely exemplary, and not intended to be limiting in any way, as each component can be arranged in various configurations, spread across a number of computing devices, combined with other components or one another, arranged to communicate over a network, or any combination of the foregoing including others not mentioned. For example, each of the operational modules may comprise a combination of hardware components and/or computer instructions stored on computer-readable media and executable on a processor thereof, as later described in regards to computing device 1500 below.

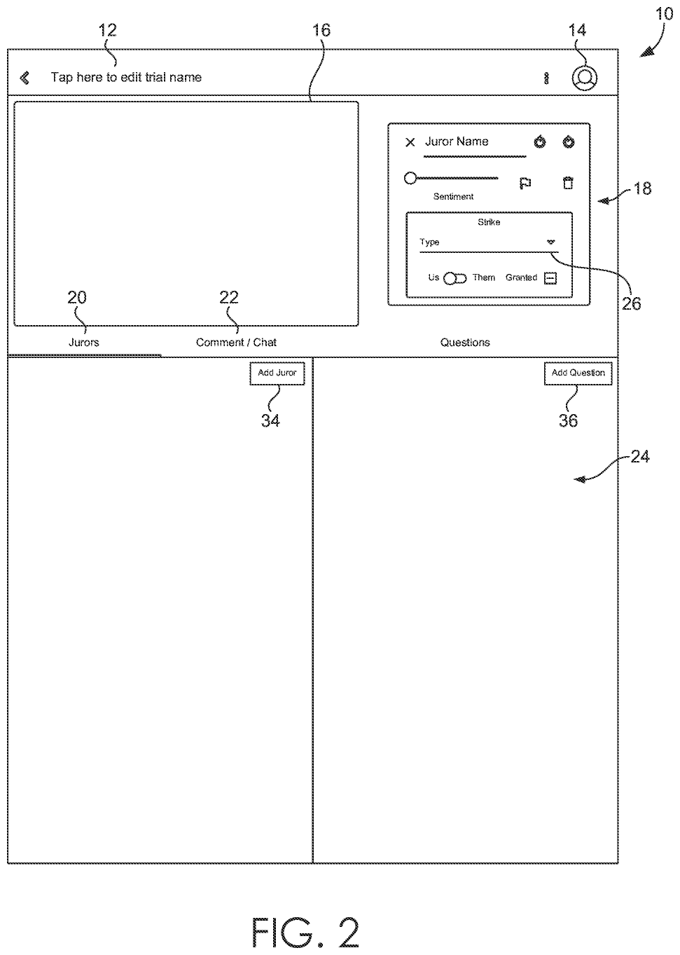

As depicted in FIG. 1B, the operational modules of the client device 115 may comprise a juror-tracking app executing component 210, a communication component 220, and a graphical user interface (GUI) component 230. The juror-tracking app executing component 210 can be configured for executing a juror-tracking app associated therewith, such as the collaborative and interactive juror tracking and analysis app described herein. In some embodiments, executing the juror-tracking app may include displaying a courtroom depiction, one or more juror icons, an associated juror list, juror questions and selectable answers, and other selectable and modifiable elements, as later described herein and depicted in FIGS. 2-13. The communication component 220 can be configured for network communications between the client device 115, the client device 120, and/or the server device 110 via the network 130. Specifically, the communication component 220 can be configured for live or real-time interaction between the client devices 115,120 and/or the server device 110 via the network 130 such that users of different ones of the client devices 115,120 can view text, changes, selections, and/or notes made within the juror-tracking app by other users on other ones of the client devices 115,120 (e.g., such as selections made by co-counsel or other members of their legal team).

The GUI component 230 can be configured for displaying the court room depiction, the one or more juror icons therein, the associated juror list, juror questions, selectable answers, and other selectable and modifiable elements and manipulatable features therein, such as menus, virtual joysticks, selection icons, selectable tabs for displaying various data, pop-up windows, fixed and/or movable objects, or the like. In some embodiments, the GUI component 230 can further comprise a selection-detecting component 240 configured for detecting a mouse click, stylus tap, or touch gesture on a touchscreen of the client device 115, as later described herein. For instance, the selection-detecting component 240 can highlight or otherwise modify one or more of the juror icons to indicate that juror is selected and can additionally or alternatively rotate and/or relocate the selected one or more juror icons within the courtroom depiction in response to selection and/or manipulation indicated by the user via a touch gesture or the like. For example, a drag-and-drop touch gesture may move a location of one of the juror icons, while a selection of a rotation tool associated with any of the juror icons may rotate a direction in which the juror icon faces. The selection-detecting component 240 and/or another sub-element of the GUI component 230 can also respond to detecting selection of certain objects or displayed data by changing or modifying a color, symbol, or other visual characteristic (e.g., pattern, line thickness, or the like) of one or more of the juror icons and/or one of the potential juror names or numbers on the associated juror list, as later described herein.

Specifically, the GUI component 230 can also comprise one or more point-totaling components 250 configured for calculating and displaying a sum of points associated with each of the answers selected thus far for each of the prospective jurors or juror icons. For example, a first answer to a first question can be stored as 10 (indicating its favorable weight) and a second answer to the first question can be stored as 0 or −5 (indicating its less-favorable weight). The point-totaling component 250 may calculate and store an ongoing total of these answer points as they are selected for each of the prospective jurors or juror icons and may display the resulting sum of points in the associated juror list proximate to each juror's name and/or number or in some other location associated with each of the juror icons. The point-totaling components 250 may display the ongoing point total continually and/or upon selection of a prospective juror name, number, or juror icon. In addition to aggregating points assigned for various answers, point values can also be weighted using a variety of techniques. In some embodiments, point calculations can be based on output of statistical regression techniques such as, but not limited to, the coefficient and intercept of linear regression.

The GUI component 230 can also comprise a juror status indication component 260 configured for tracking the status of prospective jurors and visually displaying said status. For example, the status indication component 260 can be configured to display a juror status box for each of the prospective jurors upon selection of the prospective juror's name or number or the associated juror icon. The juror status box can comprise selectable options for the juror indicating juror status, such as whether the juror is selected for the jury or whether the juror is requested to be or is removed from the pool of jurors via a peremptory strike, a for-cause strike, or excused by the court. Additionally, the selectable options can allow indication of which side of a case requested the peremptory strike or the for-cause strike. The juror status indication component 260 can further be configured to display changes to the juror icons based on the selected status of the associated juror. For example, in response to a user selection of the selectable option that the juror is being excused by the court, the juror status indication components 260 can display the associated one of the juror icons 38 as faded out or otherwise marked out (e.g., via an “X” or a strike-out symbol). Furthermore, in some embodiments, such juror status indication components 260 or graphical representations thereof displayed on or associated with the juror icon 38 can be cleared to reset the prospective juror to an active status.

The GUI component 230 can include other elements or components not displayed herein without departing from the scope of the technology herein. For example, the GUI component 230 can include elements or components configured for receiving and displaying text notes, modifying settings, creating custom question and answer options, modifying points granted for particular answer options, or any other features described herein. In some embodiments, the GUI component 230 can send live updates to the server device 110 through the network 130 via the communication component 220 of the client device 115 such that other ones of the client devices, such as the client device 120, may display any changes made via the client device 115 in real time. Note that components and capabilities of each of the client devices 115,120 identified herein may be identical to each other without departing from the scope of the technology herein. For example, the client device 120 can also include the GUI component for manipulation of juror icons and the like as described herein, as well as a communication component for communicating such juror icon manipulation to the other client devices for display thereon in real time.

Turning now to FIGS. 2-13, an example depiction of a juror-tracking app interface 10 is presented on a display screen, such as a touchscreen of a mobile electronic device. The mobile electronic device upon which the juror-tracking app interface 10 is displayed can include the computing device 1500 as described below and depicted in FIG. 15. Likewise, the display screen or touchscreen can comprise any of the I/O components 1520 described below and depicted in FIG. 15 and can be replaced with any display screen known in the art. For example, the display screen can particularly comprise embodiments of I/O components 1520 with gesture recognition on screen and touch recognition associated with a display of the computing device 1500. However, in other embodiments, the display screen can be replaced with a traditional non-touch screen or visual display device with a selection device manipulated by a mouse, trackball, joystick, or other physical selection devices.

The juror-tracking app interface 10 can include text and other graphics for tracking prospective jurors in a courtroom, including answers to questions and jury selection status, among other information as described herein. As depicted in FIG. 2, the juror-tracking app interface 10 can, upon launching or opening thereof, display a variety of black spaces for addition of graphic objects and text as later described herein. For example, a title text box 12 can be presented at a top location or any location on the display screen and can be edited by a user to display a name of a trial or the like. Furthermore, the juror-tracking app interface 10 can include a user profile icon 14 selectable by the user for inputting information regarding the user and/or preferred settings of the user while using the juror-tracking app interface 10.

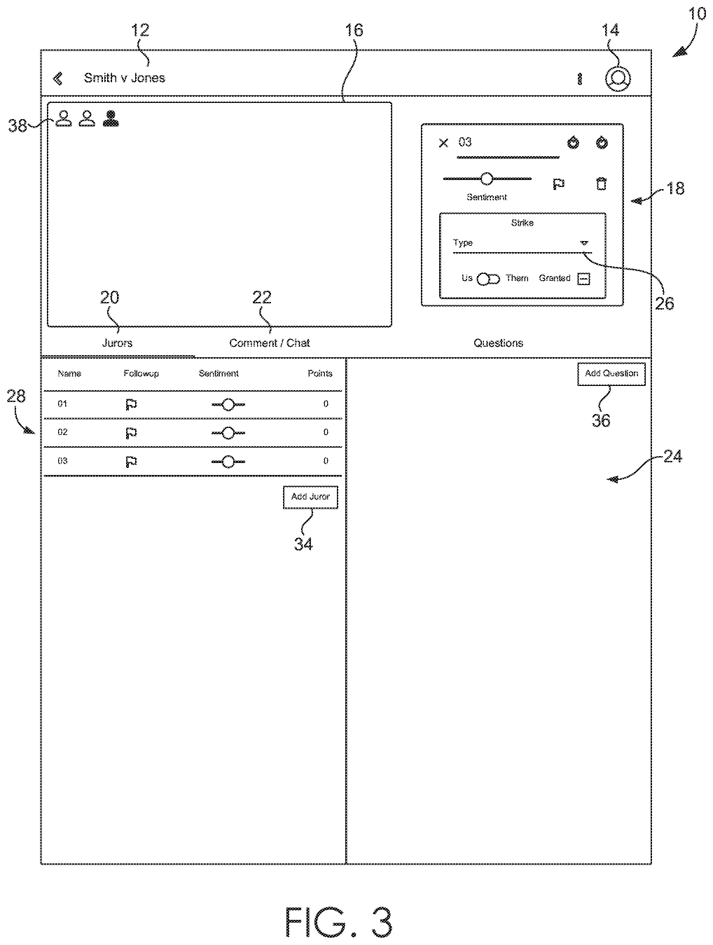

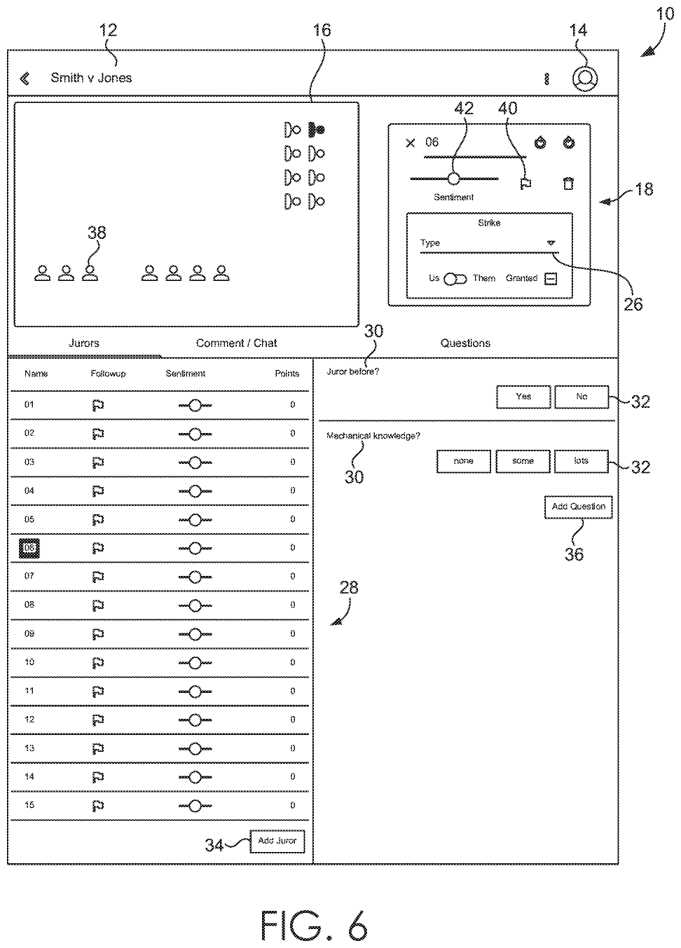

As depicted in FIG. 2, the juror-tracking app interface 10 can also include a bounded area 16, a juror status box 18, a juror list tab 20, a comment/chat tab 22, and a questions box 24. The bounded area 16 can represent walls or other boundaries of a courtroom, as later described herein. The juror status box 18 can include therein selectable juror status indicators 26 and other selectable and modifiable elements. The juror list tab 20 can be selectable for displaying a juror list 28, as later described herein and depicted in FIG. 3, while the comment/chat tab 22 is alternatingly selectable to display comments or chat with other users via the juror-tracking app interface 10 instead of the juror list 28. The question box 24 can display one or more juror questions 30 and one or more selectable answers 32 for each of the juror questions 30, as depicted in FIG. 6 and later described herein. Furthermore, selectable graphic objects or buttons such as the add-juror button 34 and the add-question button 36 can be depicted via the juror-tracking app interface 10. The add-juror button 34 can be operable to add a prospective juror by name or juror number beneath the juror list tab 20. The add-question button 36 can be operable to add a question for one or more of the prospective jurors, as well as answers and/or points associated with each answer, as later described herein.

As depicted in FIG. 3, in some embodiments, the juror-tracking app interface 10 can include a courtroom depiction, such as the bounded area 16 with the one or more juror icons 38 therein. The bounded area 16 can start out without any juror icons therein, as first depicted in FIG. 2, and the juror icons 38 can be added one by one in a variety of ways or can be added all at once by menu selection of a desired number of the juror icons 38. As depicted in FIG. 3, the bounded area 16 can be bounded by a geometric shape such as a square or a rectangle outlined around the juror icons 38 or alternatively having a solid colored geometric shape with the juror icons overlaid thereon (not shown). In some embodiments, the bounded area 16 can be selectably resized or reshaped to correspond to a configuration of the courtroom or other room in which voir dire is taking place. This may be accomplished through a settings menu or expansion tools selectable on one or more sides of the bounded area 16. For example, a menu option for resizing the bounded area 16 may include options to add or delete rows and/or columns of a square or rectangular area.

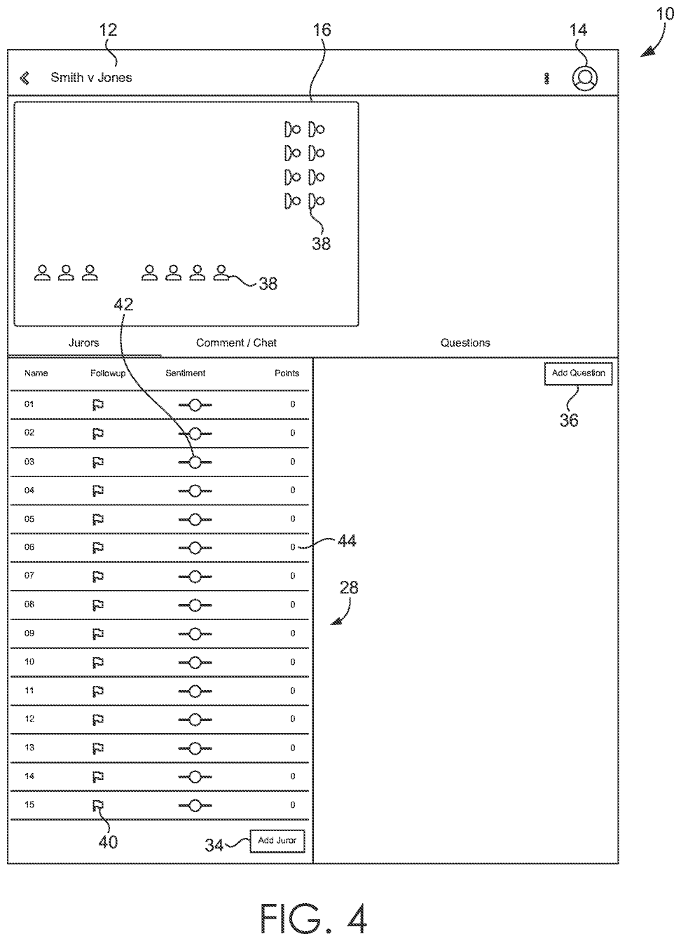

The juror icons 38 within the bounded area 16 can be visual graphics or symbols of any shape, size or configuration. In some embodiments, the juror icons 38 are each simplistic outlines of people, including a line drawing with a circular head, shoulders, arms, and/or torso. In some embodiments, the juror icons 38 may each include photographs of the prospective jurors and/or juror numbers assigned to each of the prospective jurors. As depicted in FIG. 4, the juror icons 38 can be selected and reoriented and/or moved to any one of a plurality of locations within the bounded area 16. Selection of any of the juror icons 38 may be accomplished by touching, tapping on, or clicking on one of the juror icons 38. However, other methods of selection may be used without departing from the scope of the technology described herein. Upon selection of any of the juror icons 38, a visual characteristic of those selected ones of the juror icons 38 may be changes such as highlighting the juror icon or changing colors or patterns thereof, as depicted for a third one of the juror icons 38 in FIG. 3. When one of the juror icons 38 is selected, fields associated with the corresponding prospective juror can be editable in the juror status box 18, and the question box 24 can be updated to show that prospective juror's currently selected answers. Likewise, when the comment/chat tab 22 is also selected, comments associated therewith can be filtered to include only comments or notes specific to the prospective juror whose juror icon is presently selected.

The juror icons 38 may also be deselected in accordance with some embodiments described herein. For example, a process by which a selected one of the juror icons 38 is no longer selected may also be referred to herein as deselecting of that juror icon. Deselection of one of the juror icons 38 can occur in response to a second selection (e.g., clicking, touching, or tapping on) of a selected one of the juror icons 38 or selecting of a different one of the juror icons 38, while deselection of all of the juror icons 38 can occur by selecting (e.g., clicking, tapping, or touching) a location within the bounded area 16 where there are no juror icons 38. However, other methods of deselecting one or more of the juror icons 38 may be used without departing from the scope of the technology described herein.

Relocating and/or reorienting the juror icons 38 may be accomplished via selection of one of the juror icons 38 and click-and-drag or touch-and-drag gestures. For example, if the prospective jurors are located in two rows along one wall and one more row along an adjacent perpendicular wall, the juror icons 38 can be selected and dragged into those desired rows with boundaries of the bounded area 16 representing those walls, as depicted in FIG. 4. In some embodiments, relocation of the juror icons 38 can be accomplished via directional movement buttons or selectable graphical representations thereof, such us up, down, left, or right arrows or the like. Likewise, the juror icons 38 can be reoriented to correspond with actual orientations of the juror within the courtroom, as also depicted in FIG. 4. This can be accomplished with selectable menu options for specific degrees of rotation and/or gestures, such as touch-and-rotate gestures at specific locations on the juror icons 38 via a touch screen.

As depicted in FIGS. 3-4, the juror list 28 can list names, juror numbers, and other information regarding each of the prospective jurors and corresponding to one of the juror icons 38. The juror list 28 may be located anywhere relative to the bounded area 16. For example, as depicted in FIGS. 3-4, the juror list 28 may be located below the bounded area 16. Additionally or alternatively, the juror list may be selectably-displayed upon selection of a juror list icon or selectable juror list menu option. The juror list 28 may include rows and columns listing names, juror numbers, and/or other information regarding each of the prospective jurors and corresponding to one of the juror icons 38. In some embodiments, when an associated one of the juror icons 38 is selected, a corresponding juror name, juror number, and/or other associated information can also be highlighted or otherwise visually emphasized within the juror list 28, as depicted in FIG. 6 where juror 6 in the juror list 28 is highlighted along with a corresponding one of the juror icons 38. In some embodiments, one or more of the juror icons 38 can be selected via the juror list 28 by selecting or tapping on the prospective juror's name, number, and/or other associated information or by tapping on a row in which this data is displayed. Other items in the juror list 28 may include flags 40, sentiment sliders 42, and/or juror scores 44 based on the selectable answers 32, as described below.

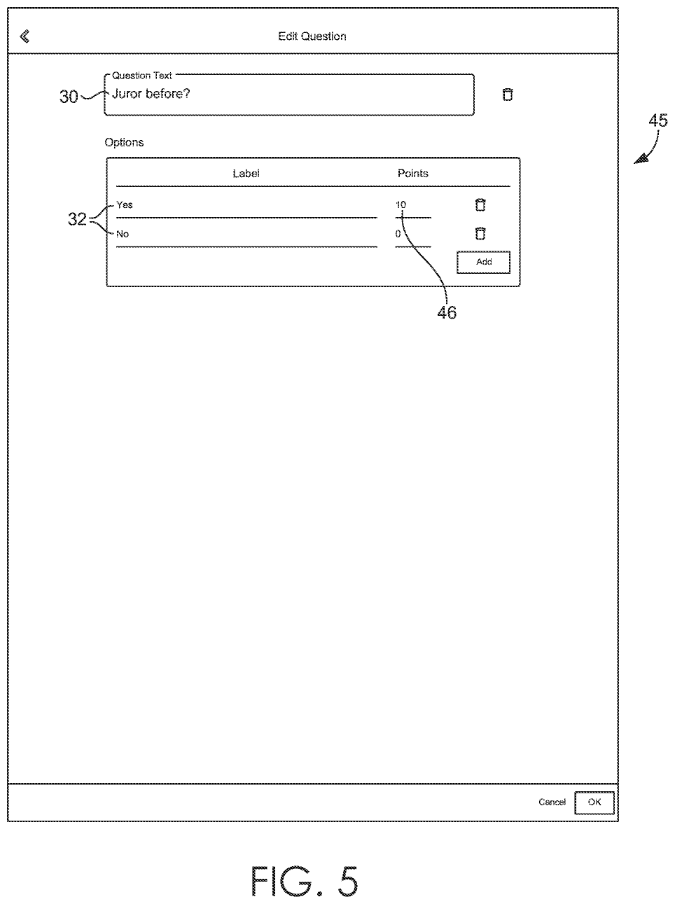

When a user clicks, touches, or otherwise selects an area within the questions box 24, a pop-up window 45 or the like can appear, as depicted in FIG. 5, and can provide selectable options for editing and/or creating questions to be posed to the potential jurors, as well as a plurality of answers to be tracked within the juror-tracking app interface 10. Those questions may be the juror questions 30 and their corresponding selectable answers 32 depicted in FIG. 6. Additionally, the options within the pop-up window depicted in FIG. 5 can include point values 46 to be assigned to each of the selectable answers 32, as later described herein. For example, in some embodiments, one or more of the questions, answers, and point values assigned to each answer can be prepopulated into the juror-tracking app interface 10 based on a selected type of case and which side of the case the users are on. Additionally or alternatively, each question, answer, and assigned point value may be manually input by the users via the pop-up window 45 or any other data input method known in the art. In addition to assignment of point values for various questions' answers, additional values can be assigned (e.g., via look-up tables or manual input by the users) such as values used to calculate a juror point valuation using statistical regression techniques (e.g., intercept and coefficient of a linear regression).

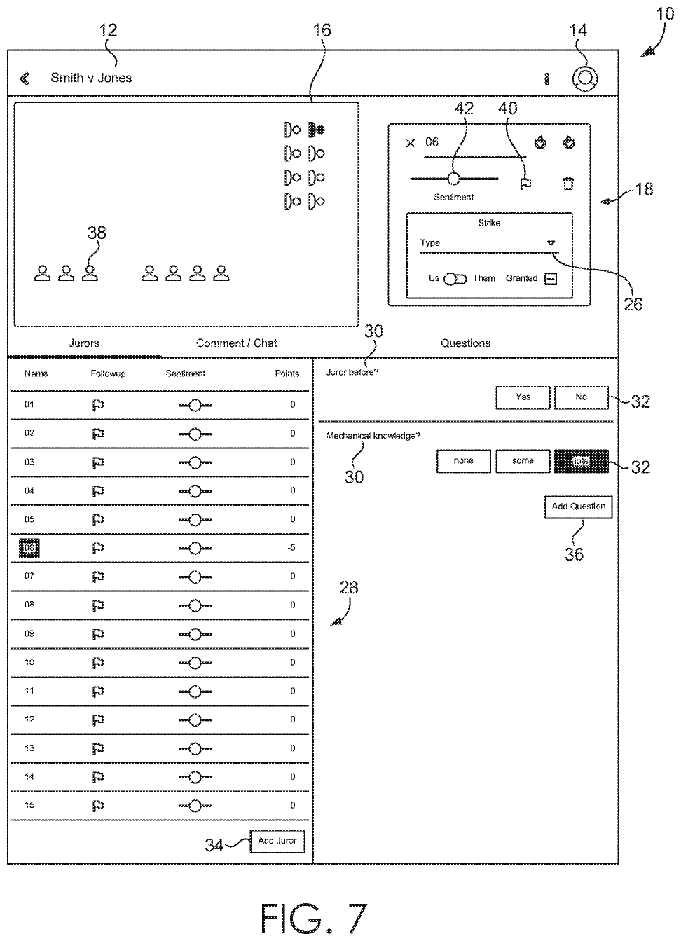

FIG. 6 depicts the questions box 24 after the juror questions 30 and their selectable answers 32 are created and/or edited. However, note that one or more default juror questions and corresponding selectable answers may be displayed in the questions box 24 without being created and/or edited by the user. The juror questions 30 and the selectable answers 32 described herein can be continually displayed via the juror-tracking app interface 10. For example, in some embodiments, the juror questions 30 and selectable answers 32 can be displayed adjacent to and right of the juror list 28. However, any display location can be used without departing from the scope of the technology described herein. In some embodiments, the juror questions 30 and the selectable answers 32 can be selectably displayed based on a particular setting or selection by a user. The selectable answers 32 can be positioned immediately below or next to (e.g., right of) corresponding ones of the juror questions 30. A predetermined color or other visual characteristic can indicate when any one of the selectable answers 32 is selected, as depicted in FIG. 7.

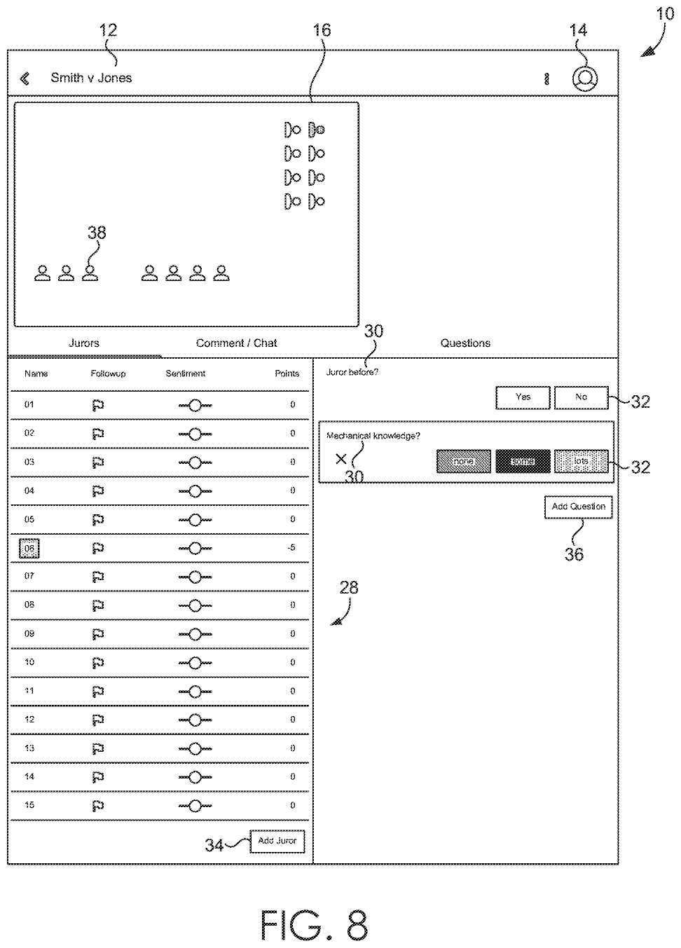

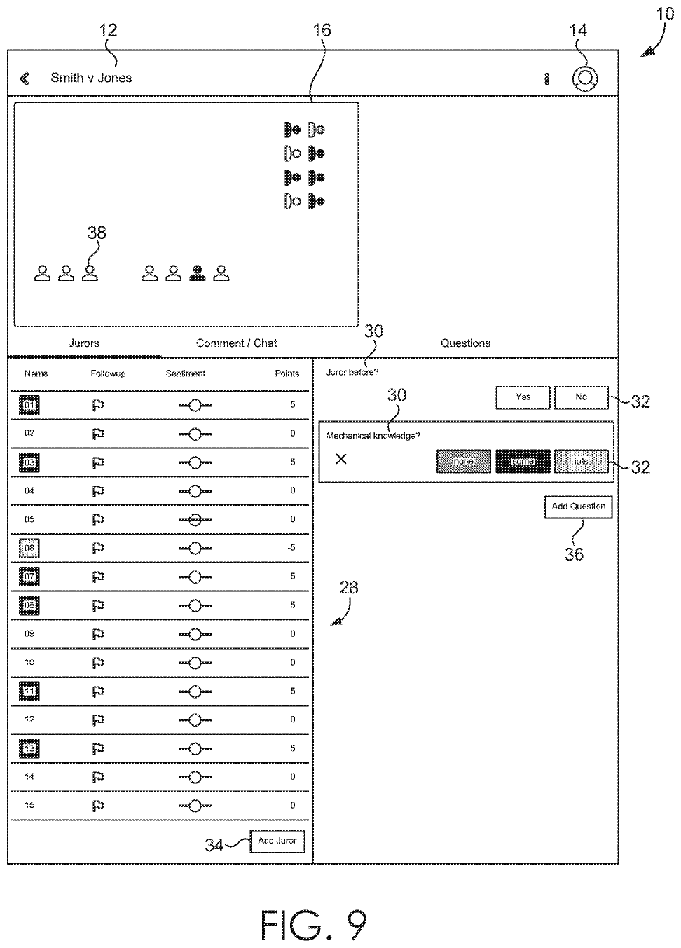

In some embodiments, the selectable answers 32 can operate in an individual juror selection mode, as depicted in FIG. 7, or in a group selection mode, as depicted in FIGS. 8-9. The individual juror selection mode, as depicted in FIG. 7, can be selected by a user, such as by selecting one of the prospective jurors or an associated one of the juror icons 38 when none of the selectable answers 32 is selected. Then, the selected one of the juror icons 38 may remain highlighted or otherwise indicate that it is selected, and ones of the selectable answers 32 indicated in the courtroom during voir dire by a corresponding one of the prospective jurors can be recorded by user selection. In the individual juror selection mode, ones of the selectable answers 32 corresponding to the selected one of the juror icons 38 can be visually indicated by highlighting, changing of color, pattern, bolding, or some other graphic change.

The group selection mode, as depicted in FIGS. 8-9, can be selected by a user or can be a default mode when none of the prospective jurors or their associated juror icons 38 are selected and then one of the selectable answers 32 is selected. FIG. 8 depicts one of the selectable answers 32 as selected in the group selection mode (e.g., “some”) while none of the juror icons 38 are selected. FIG. 8 also depicts other non-selected ones of the selectable answers (e.g., “lots”) still visually associated with one or more of the prospective jurors based on prior answer selections. For example, FIG. 7 depicted juror 6 being selected and then the answer “lots” being selected. Thus, in FIG. 8 when all of the juror icons 38 are deselected and one of the answers (i.e., “some”) is selected, juror 6 and its associated juror icon can still display a color or pattern corresponding to the answer “lots”.

Then, as depicted in FIG. 9, more than one of the juror icons 38 can be selected in the group selection mode following selection of one of the selectable answers 32 (e.g., “some” in FIG. 9), thereby linking that one of the selectable answers 32 to that plurality of prospective jurors associated with those particular juror icons 38. This allows questions answered by a show of hands to be easily recorded in real time during voir dire. Furthermore, for each of the juror questions 30, distinct visual indicators or distinctly different patterns or colors can be associated with each of the selectable answers 32. Thus, when any one of the juror questions 30 and/or specific ones of the selectable answers 32 associated with one of the juror questions 30 is selected in the group selection mode, the juror icons 38 are likewise visually associated with corresponding ones of the selectable answers 32, as depicted in FIG. 9. Specifically, if the answer to whether or not a prospective juror has mechanical knowledge is “none,” “some,” or “lots,” then “some” may be highlighted in yellow and each of the juror icons 38 whose associated prospective juror answered “some” to that question during voir dire can also be shown in yellow. Likewise, “lots” can be highlighted in orange, and each of the juror icons 38 whose associated prospective juror answered “lots” to that question can be shown in orange.

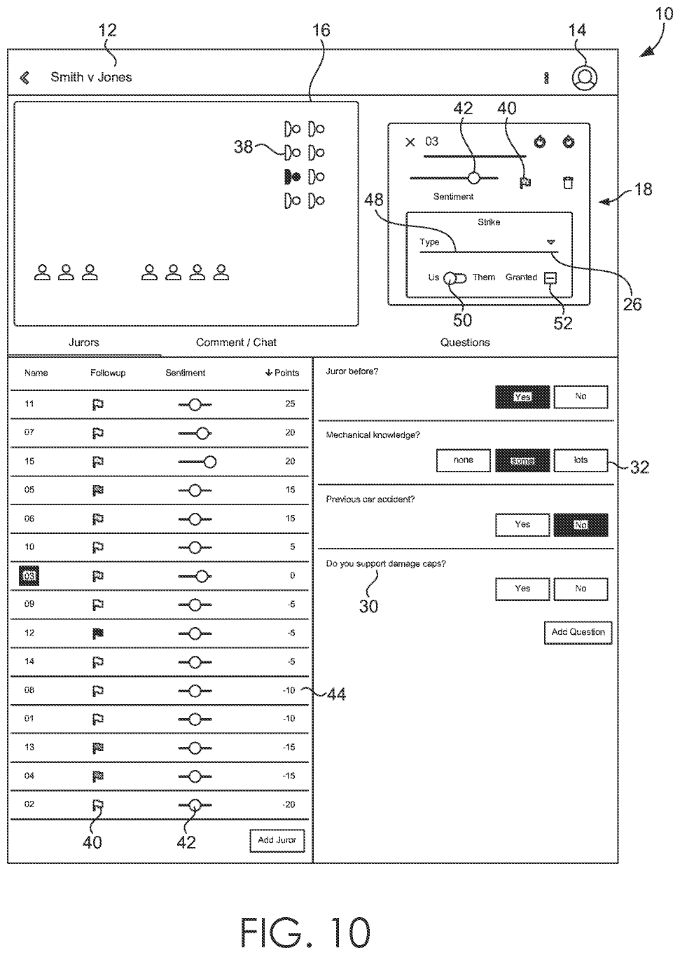

As depicted in FIG. 10, the flags 40, the sentiment sliders 42, and the juror scores 44 can be depicted in the juror list 28 and/or the juror status box 18 which can be displayed, for example, when one of the juror names or numbers on the juror list 28 is selected and/or when a corresponding one of the juror icons 38 is selected. The flags 40 and the sentiment sliders 42 are configured for recording instant feedback regarding any selected ones of the juror icons 38. The selectable flags 40 or other such indicators can be selected on or off for follow-up and/or can be selected to display different colors or patterns for categorizing of a corresponding prospective juror. Although depicted in a shape of a flag, other icons or graphic symbols can be used for the selectable flags 40 without departing from the scope of the technology described herein. In some embodiments, one of the juror icons 38 corresponding to one of the prospective jurors can be flagged and repeated tapping of any of the flags 40 can cycle through a number of colors that can be used to indicate various categories or meanings indicated thereby.

As depicted in FIG. 10, the sentiment sliders 42 can be manipulatable objects configured to be moved between two ends of a line or track, such that a location of one of the sentiment sliders 42 along that line or track indicates if selection for the jury of a corresponding one of the prospective jurors is perceived to be positive or negative to the user's side of a case. However, the selectable sliders 42 can be replaced with other methods and techniques for indicating a positive, neutral, or negative sentiment regarding any one or more of the prospective jurors (such as a numerical sentiment score or the like) without departing from the scope of the technology described herein. The sentiment sliders 42 can be useful in capturing subjective feelings or instincts regarding a given one of the prospective jurors in real time without requiring typing of notes or providing time-consuming explanations.

The juror scores 44, as depicted under the heading “Points” in the juror list 28 in FIG. 10, are running totals of points associated with the selectable answers 32 selected for each of the prospective jurors. As noted above, various point values can be associated with each of the selectable answers 32. Thus, each time one of the selectable answers 32 for the juror questions 30 is selected for a particular one of the prospective jurors or juror icons 38, the one of the juror scores 44 for that prospective juror is updated accordingly. For example, in FIG. 9, juror six has a juror score of negative five. However, in FIG. 10, upon selection of other selectable answers 32 for juror number six, that same juror score is increased to fifteen. The running total of points (i.e., the juror scores 44) can be displayed selectably or continuously in association with each of the juror names or juror numbers in the juror list 28 or elsewhere in association with the juror icons 38.

Note that in some embodiments, options to purchase proprietary analytics based on a case type, venue, plaintiff identity, and other factors in the case can be provided via a menu option or selectable graphic object. These proprietary analytics can be loaded to automatically provide particular predetermined voir dire questions based on the analytics and/or to pre-weight points for particular answers to particular voir dire to enhance the likelihood of winning the trial based on the analytics. Such analytics can be provided by a provider of the juror-tracking app interface 10 or a third party, and in some embodiments, can include analytics gathered through various users of the juror-tracking app interface 10. For example, the questions provided for a specific type of case or other such variables can be pre-set questions that statistical analysis has revealed to be useful in improving jury selection in that specific case or cases similar thereto.

Similarly, in some embodiments, background information can be obtained directly via the juror-tracking app interface 10 on the prospective jurors using biographical information such as the prospective juror's name, address, age, or the like. For example, data such as past criminal records, property ownership, involvement in litigation, information about the neighborhood they live in, past job history, leadership experience, known relationships, and other such data points can be provided via the juror-tracking app interface 10. The data on prospective jurors can be automatically sorted into various categories for ease of use and/or uploaded as part of a profile on that particular prospective juror and, in some embodiments, can be used to help score the prospective jurors in automated or manually-selected ways, or used to influence the sentiment sliders 42 described herein.

Similarly, some embodiments can provide uploads of and access to a variety of form motions relating to jury selection, such as form motions to exclude for cause, motions relating to proper scope of voir dire, motions relating to rehabilitation of jurors, or other jury selection issues. Additionally or alternatively, the juror-tracking app interface 10 can provide form questionnaires that attorneys can propose for courts. This and the other capabilities of the technology described herein advantageously allows the juror-tracking app interface 10 to be a one-stop platform for pre-jury selection research, jury selection scoring, and motions relating to jury selection.

As depicted in FIGS. 10-12, the juror status box 18 and the corresponding juror status indicators 26 can be displayed next to the bounded area 16 and above the juror questions 30 and selectable answers 32. However, other locations for displaying the selectable juror status indicators 26 may be used without departing from the scope of the technology herein. In some embodiments, the juror status box 18 is presented, including the selectable juror status indicators 26 positioned therein, upon selection of one of the prospective jurors in the juror list 28 or their associated juror icons 38.

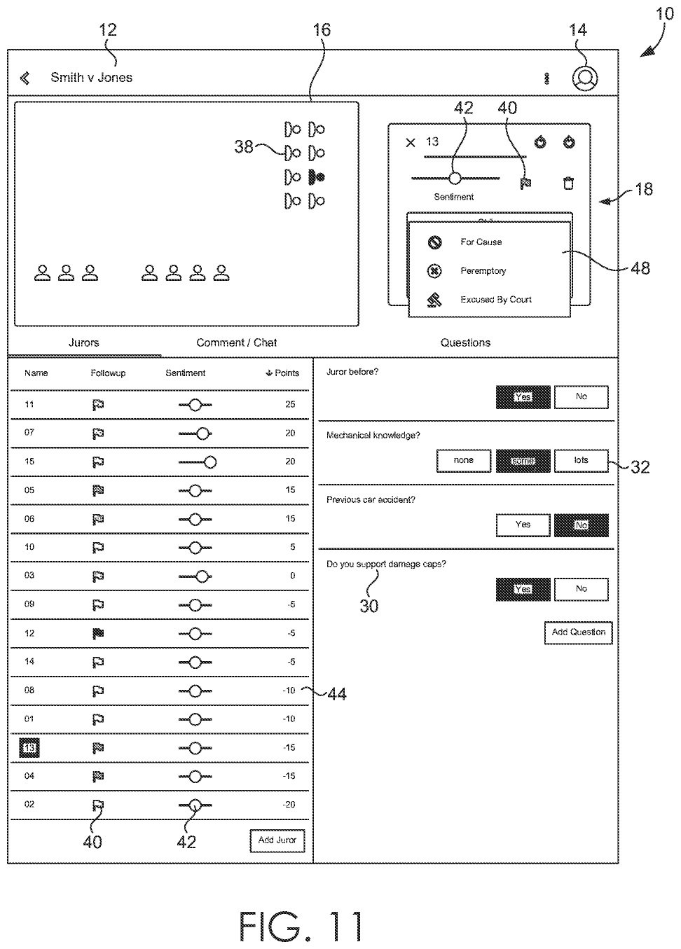

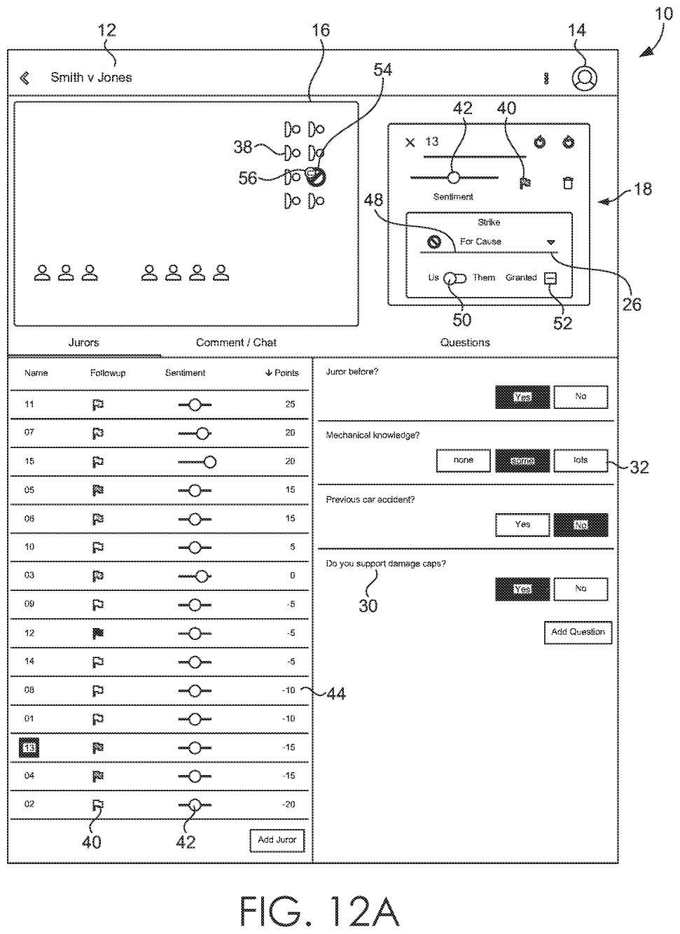

The selectable juror status indicators 26 can comprise a menu of selectable objects (such as the drop-down menu 48 displayed in FIG. 11) and/or selectable text indicating one or more of the following: a peremptory strike, a for cause strike, excused by the court, and selected for jury. In some embodiments, the selectable juror status indicators 26 can also comprise an us-or-them indicator 50. The us-or-them indicator 50 provides the users with an option to indicate if a strike was requested by the user's side in a case (i.e., “us”) or opposing counsel's side in a case (i.e., “them”). For example, if a user selects one of the juror icons 38, then selects a peremptory strike option, the user can also move a slider of the us-or-them indicator 50 or otherwise indicate that the peremptory strike was requested by “us” or the user's side of the case. Furthermore, in some embodiments, a “granted” box 52 may be selectably checked to indicate if the requested strike was granted. However, other selectable objects for indicating whether or not a requested strike was granted may be used without departing from the scope of the technology described herein.

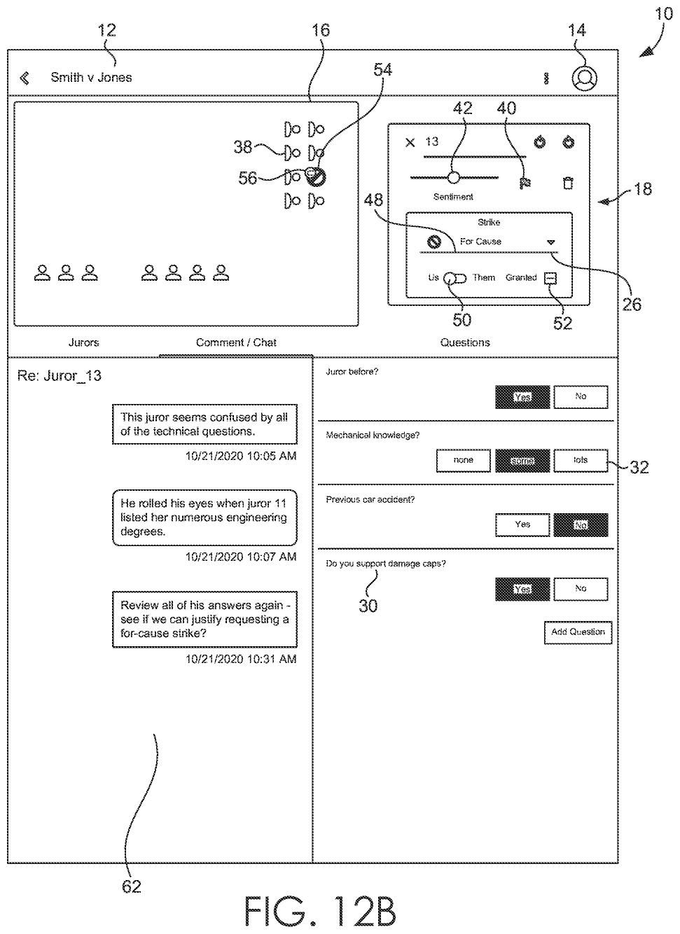

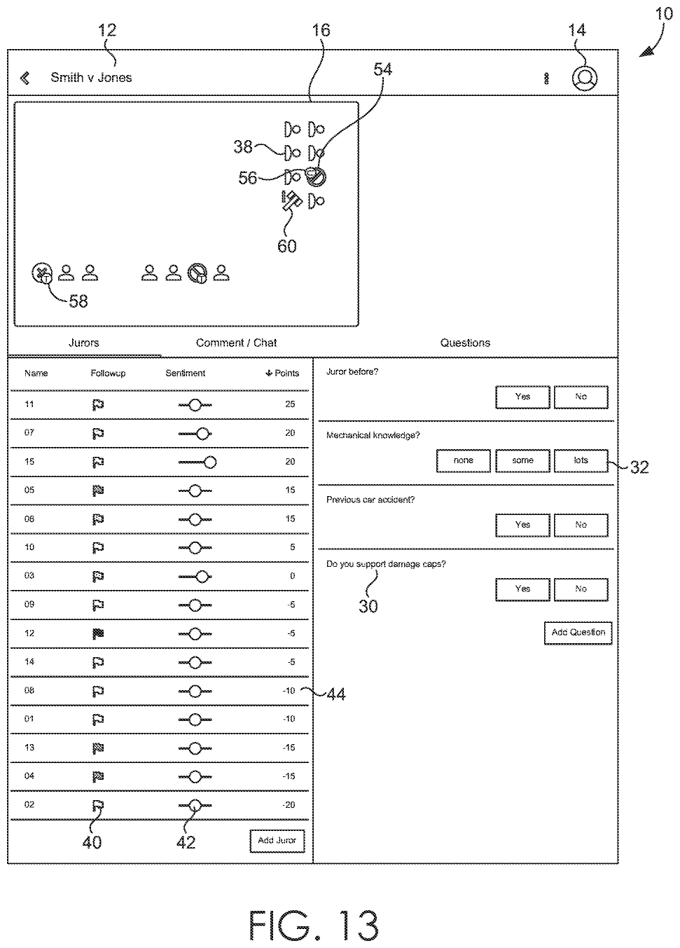

As illustrated in FIGS. 12a-13, the user selecting specific ones of the selectable juror status indicators 26 can also result in changes to visual characteristics of the juror icons 38, visually indicating requested or granted jury selection status for corresponding ones of the prospective jurors in the courtroom. For example, a “for cause” strike icon 54 placed over one of the juror icons 38 may be depicted with a circle having a diagonal line extending therethrough, as in FIG. 12a. In some example embodiments, a requested action may be illustrated in full color (e.g., a strike-through icon placed over or in place of one of the juror icons 38), while an action granted by the judge may be depicted in black and white or in faded colors, such that only the remaining prospective jurors are in full color. Likewise, which side requested a strike can also be indicated on corresponding ones of the juror icons 38, such as with a small “u” (labeled 56 in FIGS. 12-13) standing for “us” and a small “t” (labeled 58 in FIG. 13) for them. However, other visual indicators can be used without departing from the scope of the technology described herein. Furthermore, in some embodiments, the juror icons 38 may be completely replaced with visual indicators depicting juror status, such as in FIG. 13 wherein one of the juror icons representing a prospective juror excused by the court is replaced with a depiction of a gavel 60.

In summary, the juror icons 38 are described herein as denoting the physical location and orientation and the strike status of the prospective jurors, and the coloring of the juror icons 38 can indicate whether the prospective jurors are selected or, if a question is selected, each prospective juror's response to the question. However, other attributes of the prospective jurors could be displayed graphically on the courtroom floor where the juror icons 38 are located, such as a color of the prospective juror flag, a visual representation of the prospective juror's sentiment, or a visual representation of the point calculation of the prospective juror. Other visualizations of any prospective juror attributes described herein or otherwise can be used without departing from the scope of the embodiments herein.

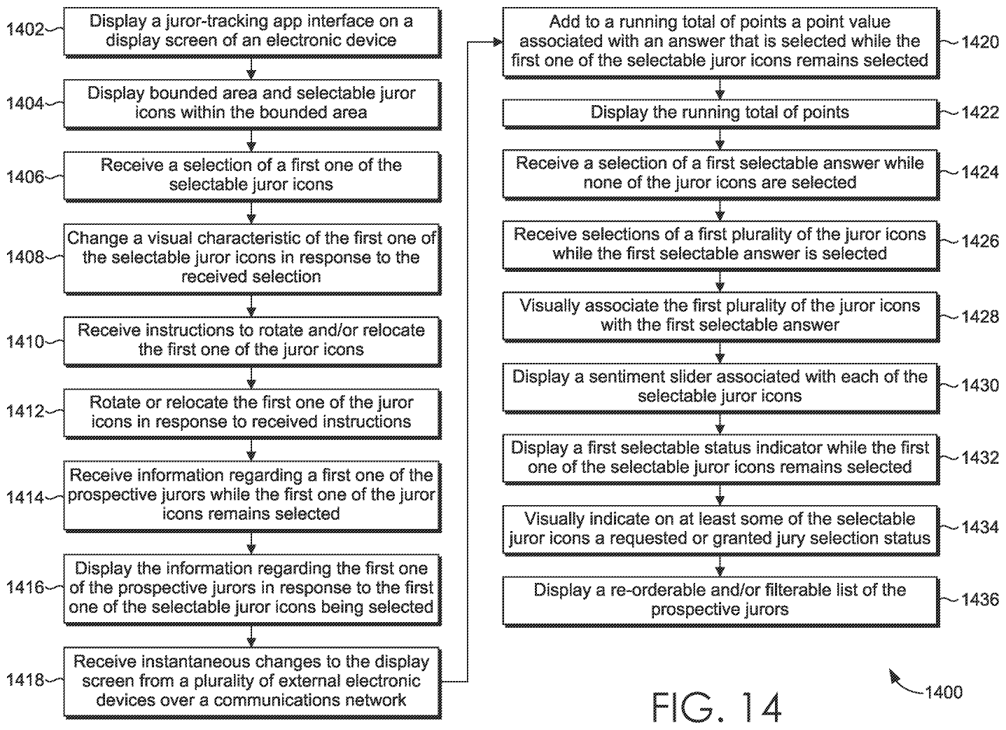

Now referring to FIG. 14, each block of method, described herein, comprises a computing process that can be performed using any combination of hardware, firmware, and/or software. For instance, various functions can be carried out by a processor executing instructions stored in memory. The method can also be embodied as computer-usable instructions stored on computer storage media. The method 1400 can be provided by a standalone application, a service or hosted service (standalone or in combination with another hosted service), or a plug-in to another product, to name a few. For example, as described herein, the method 1400 is a virtual tool within other software such as a case management app. In addition, the method 1400 is described, by way of example, with respect to the juror-tracking app interface 10 on the touchscreen of FIGS. 2-13. However, these methods can additionally or alternatively be executed by any one system, or any combination of systems, including, but not limited to, those described herein.

Now referring to FIG. 14, a flow diagram depicts a method 1400 for juror selection tracking and analysis via a juror-tracking app interface 10, in accordance with some embodiments of the present disclosure. In accordance with various embodiments, the method 1400 can be employed to collaboratively track and analyze prospective juror answers to a variety of questions, gather other notes and information regarding the prospective jurors, and requested or granted statuses of each of the prospective jurors. As depicted in block 1402, the method 1400 can comprise a step of displaying a juror-tracking app interface 10 on a display screen of an electronic device, such as the client devices 115,120 described herein. The juror-tracking app interface 10, as described above, can include graphics and text communicating information regarding any of the prospective jurors in the courtroom either continually or each time one of the juror icons 38 is selected or a prospective juror name or number is selected in the juror list 28.

As depicted in block 1404, the method 1400 can comprise a step of displaying both the bounded area 16 representing a courtroom and the selectable juror icons 38 within the bounded area 16. As noted above, the juror icons 38 each represent one of the prospective jurors in the courtroom. Orientations of each of the juror icons 38 represent directions that the prospective jurors in the courtroom are facing, while locations of each of the juror icons 38 within the bounded area represent corresponding locations of the prospective jurors in the courtroom.

As depicted in block 1406, the method 1400 can comprise receiving a selection of a first one of the selectable juror icons 38. Furthermore, as depicted in block 1408, the method 1400 can comprise changing, in response to receiving the selection of block 1406, a visual characteristic of the first one of the juror icons 38, indicating that the first one of the juror icons 38 is selected. The selectable juror icons, as identified herein, may include any of the juror icons 38 described above. In one example embodiment, upon receiving a selection of one of the juror icons 38 and/or a corresponding prospective juror name or number, the name and/or number of that prospective juror in the juror list 28 may be highlighted or may change colors to a color that indicates selection thereof. In some embodiments, as depicted in block 1410, the method 1400 can comprise receiving instructions to rotate the first one of the juror icons 38 and/or relocate the first one of the juror icons 38. In response to receiving the instructions of block 1410, as depicted in block 1412, the method 1400 can comprise rotating or relocating the first one of the juror icons 38.

As depicted in block 1414, the method 1400 may further include receiving information regarding the first one of the prospective jurors in the courtroom while the first one of the juror icons 38 remains selected and, as depicted in block 1416, displaying on the display screen the information regarding the first one of the prospective jurors in the courtroom each time the first one of the selectable juror icons 38 is selected. When the first one of the juror icons 38 is first selected and then when one of the selectable answers 32 is touched, tapped, or clicked, it becomes associated with the first one of the juror icons 38. Thus, receiving information regarding any of the prospective jurors can include displaying juror questions 30 asked of the prospective jurors in the courtroom and displaying the selectable answers 32 to each of those questions. For example, previously-selected ones of the selectable answers 32 can be displayed or indicated each time the first one of the juror icons 38 is tapped, touched, or clicked, in addition to other information about an associated one of the prospective jurors. Information regarding any of the prospective jurors can also include information populated into the juror list 28, including the flags 40, the sentiment sliders 42, and the juror scores 44 described above.

Furthermore, as depicted in block 1418, some embodiments of the method 1400 can comprise receiving instantaneous changes to the display screen (e.g., via the juror-tracking app interface 10) from a plurality of external electronic devices over a communications network. For example, answers to various questions selected for one or more of the prospective jurors can be indicated as selected on a plurality of client devices simultaneously, such as the client devices 115,120 described herein. Likewise, a text box provided and accessed via selection of a notes tab or other such selectable access links can receive text therein regarding one or more of the prospective jurors. This received text may be viewed live on multiple client devices simultaneously and may be edited live or responded to live by multiple users via multiple client devices. Such communication and live updating via the juror-tracking app interface 10 can allow for collaboration among a plurality of members of a legal team during voir dire.

As noted above, various point values can be associated with each of the selectable answers. For example, a first one of the various point values may be associated with a first one of the selectable answers. Thus, as depicted in block 1420, the method 1400 can further include adding the first one of the various point values to a running total of points when the first one of the selectable answers is selected while the first one of the selectable juror icons remains selected. Furthermore, as depicted in block 1422, the method 1400 can include displaying the running total of points for the first one of the selectable juror icons, such as in an associated entry in the juror list 28 or any location on the display screen associated with the first one of the selectable juror icons. Specifically, the running total of points can be displayed selectably or continuously in association with the first one of the juror icons.

In some embodiments, the method 1400 can include associating the same answer for multiple potential jurors and their corresponding juror icons 38. Specifically, as depicted in block 1424, the method 1400 can include receiving a selection of the first one of the selectable answers while none of the juror icons are selected. Specifically, as described above, this may require deselection of all of the juror icons 38 prior to selection of an answer to a particular question. Thus, block 1424 may occur when none of the juror icons 38 have yet been selected and/or may occur following deselection of all of the juror icons 38.

Following selection of one of the answers while none of the juror icons are selected, the method 1400 can include a step of receiving selections of a first plurality of the juror icons 38, as depicted in block 1426. For example, following deselection of all of the juror icons 38, the answer “some” to a question can be selected (as depicted in FIG. 8), and then six of the juror icons 38 can be selected (as depicted in FIG. 9), thus indicating that the six prospective jurors associated with those juror icons 38 provided the answer “some” to a question regarding their mechanical knowledge. Specifically, as depicted in block 1428, the method 1400 can include a step of visually associating the first plurality of the juror icons 38 with the first one of the selectable answers. This visual association indicates prospective jurors in the courtroom who chose specific ones of the selectable answers 32. For example, a given color may be associated with a selected one of the answers, and ones of the juror icons 38 associated therewith may also be displayed in that same color. Furthermore, other answers to that same question can be provided in alternative colors, and the juror icons 38 associated with prospective jurors who gave those other answers may also be provided in those alternative colors when that question or any of the answers to that question are selected as in block 1424.

As depicted in block 1430, the method 1400 can also include a step of displaying the sentiment slider 42 associated with each of the selectable juror icons 38. The sentiment slider 42 is selectable to slide between a positive sentiment and a negative sentiment associated with each of the prospective jurors in the courtroom. However, the sentiment slider 42 may comprise other methods and techniques for indicating a positive, neutral, or negative sentiment regarding any one or more of the prospective jurors. This can be useful in capturing more subjective feelings or instincts regarding a given one of the prospective jurors in real time without requiring typing of notes or providing time-consuming explanations.

As depicted in block 1432, the method 1400 can also include a step of displaying a first selectable status indicator (e.g., the selectable juror status indicators 26) while the first one of the selectable juror icons 38 remains selected. In this example, the first selectable status indicator can be associated with the first one of the prospective jurors in the courtroom and the corresponding one of the juror icons 38. When selected, the first selectable status indicator can visually indicate at least one of the following was requested or has been granted by a judge of the courtroom in regards to the first one of the prospective jurors in the courtroom: a peremptory strike, a for cause strike, excused by the court, and selected for jury. For instance, for each of the potential jurors, upon selection of the potential juror's name or number or the associated juror icon, the juror status box 18 can be displayed and can comprise selectable options for indicating juror status, as described above. Users can update statuses of particular prospective jurors via selections of options within this juror status box while one of the juror icons 38 is selected.

Furthermore, as depicted in block 1434, the method 1400 can include a step of visually indicating on at least some of the selectable juror icons 38 requested or granted jury selection status for corresponding ones of the prospective jurors in the courtroom. The requested or granted jury selection status can be at least one of the following: a peremptory strike, a for cause strike, excused by the court, and selected for jury. For example, a requested action may be illustrated in full color (e.g., a strike-through icon placed over or in place of one of the juror icons 38), while an action granted by the judge may be depicted in black and white or in faded colors, such that only the remaining prospective jurors are in full color. As illustrated in FIGS. 11-13, a for-cause strike can be depicted with a circle having a diagonal line therein, a peremptory strike can be depicted with a circle having an “x” therein, and excused by court can be depicted via a gavel icon. However, other symbols and juror status options can be provided without departing from the scope of the technology described herein.

Additionally or alternatively, visually indicating the jury selection status can further include visually indicating which side of a case is requesting the peremptory strike or the for cause strike for that prospective juror. For example, the us-or-them indicator 50 can be selected to indicate whether the user's side (i.e., “us”) is planning to or has requested the peremptory strike or whether the opposing counsel (i.e., “them”) has requested the peremptory strike for that particular prospective juror. Selection of either of these indicators can result in a corresponding indication on a corresponding one of the juror icons 38 (e.g., a “U” or a “T” placed onto the corresponding juror icon as in FIG. 13). This can assist in tracking how many strikes are remaining for each side and which prospective jurors are now unavailable or are unlikely to be selected for the jury.

In some embodiments, as depicted in block 1436, the method 1400 can comprise displaying a list of the prospective jurors in the courtroom corresponding to the selectable juror icons 38. For example, the juror list 28 can include a plurality of rows and columns and can include one or more of the following: potential juror names, potential juror numbers assigned in the case, the running total of points (e.g., the juror scores 44) for each of the potential jurors, user-selectable flags 40 or other such indicators for categorizing or following up with particular ones of the prospective jurors, location of the sentiment slider 42, or other relevant information regarding each of the prospective jurors as described herein. The juror list 28 can be filtered and/or reordered according to at least one of the following: answers to questions as recorded for each of the prospective jurors, selected locations of sentiment sliders 42 associated with each of the selectable juror icons 38, assigned juror number, alphabetical order of prospective juror names, the flags 40 or corresponding categories selected for any of the prospective jurors, or a requested or granted jury selection status of each of the prospective jurors.

In some embodiments where display space is limited on a client device, additional information regarding each prospective juror in the juror list 28 may be accessed by selecting links leading to pop-up windows or selecting tabs that open to additional information regarding those prospective jurors, such as notes for each of the prospective jurors on the juror list 28 being revealed via selection of the comment/chat tab 22. As depicted in FIG. 12b, selecting the comment/chat tab 22 causes a comment panel 62 to be displayed. The comment panel 62 can contain a list of comments made in chronological order, grouping comments together (e.g., in speech bubbles) to make comments made in a particular timeframe by a particular user more easily identifiable. Comments in the comment panel 62 can be suffixed with the date and/or time the comment was made and comments that are specific to a particular prospective juror can have a corresponding indicator (e.g., Re: <Juror_Name> or <Juror_Number>). New comments can be added using a text entry field at a bottom of the comment panel 62. When no juror is selected, the comment panel 62 can contain all comments/chat that has occurred or all comments/chat that are not specific to individual prospective jurors. However, when a specific one of the juror icons 38 is selected, then the comments can be filtered to only contain those comments specific to the selected one of the prospective jurors and new comments made will likewise be recorded as corresponding to that specific one of the juror icons 38.

Voice capture capabilities can also be included in some embodiments of the technology described herein. For example, when one of the selectable juror icons 38 is selected, a record option (not shown) can be graphically presented and is selectable to record the associated prospective juror's voice during answering of a question. Furthermore, various voice capture features can be presented to utilize voice to test conversion and then relate that audio to the corresponding prospective juror. Furthermore, such functionality can provide highlighting capabilities such that specific relevant statements in the text converted from audio or otherwise entered into the comments. This can allow highlighting of statements that are germane to motions relating to the prospective juror, such as striking for cause, and can also use different colored highlights to represent different purposes. The audio recording capabilities and highlighting functionality is especially advantageous for providing reasons to a judge for requested strikes, and can be read or played back for the court.

Similarly, in some embodiments the technology described herein can be configured for live video integration with various videoconference platforms. For example, the juror-tracking app interface 10 can be implemented as a plug-in to ZOOM, the video-conferencing app by Zoom Video Communications, Inc. in San Jose, Calif. This can eliminate lag time in communicating regarding jury selection.

In addition to the embodiments described above, some embodiments of the juror tracking app interface 10 can further include other menu options, such as menu options for exporting and/or emailing data therefrom. For example, a main menu can have an option that, when selected, provides instant or automatic export and/or emailing of contents of a particular trial to one or more of the users or other individuals. Additionally, some embodiments of the juror tracking app interface 10 can use various screen-sharing methods to share trial information collected thereby with other users at a later time or in real time. Specifically, some embodiments can allow inviting people to become members on a particular trial (e.g., collaborators) based on email address, username/membership to the juror tracking app or its services, and/or prior collaboration on a trial via the juror tracking app associated with the juror tracking app interface 10. In some embodiments, an invitee can be notified by email and provided a multi-character code that can be entered on a trial list screen. Additionally or alternatively, such invites can appear within an invitee's juror tracking app interface 10, such as on a trial list screen or main menu where such invitations can be accepted by the invitee.

Having described embodiments of the present disclosure, an exemplary operating environment in which embodiments of the present disclosure can be implemented is described below in order to provide a general context for various aspects of the present disclosure. Referring initially to FIG. 15 in particular, an exemplary operating environment for implementing embodiments of the present disclosure is shown and designated generally as computing device 1500. Computing device 1500 is but one example of a suitable computing environment and is not intended to suggest any limitation as to the scope of use or functionality of the disclosed embodiments. Neither should the computing device 1500 be interpreted as having any dependency or requirement relating to any one or combination of components illustrated.

The embodiments herein can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The described embodiments can be practiced in a variety of system configurations, including hand-held devices, consumer electronics, general-purpose computers, more specialty computing devices, etc. The described embodiments can also be practiced in distributed computing environments where tasks are performed by remote-processing devices that are linked through a communications network.

With reference to FIG. 15, computing device 1500 includes a bus 1510 that directly or indirectly couples the following devices: memory 1512, one or more processors 1514, one or more presentation components 1516, input/output (I/O) ports 1518, input/output (I/O) components 1520, and an illustrative power supply 1522. In some example embodiments, the computing device 1500 can be or can comprise a mobile electronic device such as a smart phone, tablet, touchscreen laptop, or the like. Bus 1510 represents what can be one or more busses (such as an address bus, data bus, or combination thereof). Although the various blocks of FIG. 15 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventor recognizes that such is the nature of the art, and reiterates that the diagram of FIG. 15 is merely illustrative of an exemplary computing device that can be used in connection with one or more embodiments of the present disclosure. Distinction is not made between such categories as “workstation,” “server,” “laptop,” “hand-held device,” etc., as all are contemplated within the scope of FIG. 15 and reference to “computing device.”

Computing device 1500 typically includes a variety of computer-readable media. Computer-readable media can be any available media that can be accessed by computing device 1500 and includes both volatile and nonvolatile media, and removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1500. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1512 includes computer-storage media in the form of volatile and/or nonvolatile memory. The memory can be removable, non-removable, or a combination thereof. Exemplary hardware devices include solid-state memory, hard drives, optical-disc drives, etc. Computing device 1500 includes one or more processors that read data from various entities such as memory 1512 or I/O components 1520. Presentation component(s) 616 present data indications to a user or other device. Exemplary presentation components include a display device, speaker, printing component, vibrating component, etc.

I/O ports 1518 allow computing device 1500 to be logically coupled to other devices including I/O components 1520, some of which can be built in. Illustrative components include a microphone, joystick, game pad, satellite dish, scanner, printer, wireless device, etc. The I/O components 1520 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1500. The computing device 1500 can be equipped with depth cameras, such as stereoscopic camera systems, infrared camera systems, RGB camera systems, touchscreen technology, and combinations of these, for gesture detection and recognition. Additionally, the computing device 1500 can be equipped with accelerometers or gyroscopes that enable detection of motion. The output of the accelerometers or gyroscopes can be provided to the display of the computing device 1500 to render immersive augmented reality or virtual reality.

As can be understood, embodiments of the present disclosure provide for, among other things, systems and methods for tracking and analyzing prospective jurors. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that embodiments of the present disclosure are one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

1. A computer-implemented method for juror selection tracking and analysis, the method comprising:
displaying on a display screen of an electronic device a bounded area representing a courtroom and one or more selectable juror icons within the bounded area, wherein the selectable juror icons represent one or more prospective jurors in the courtroom;
receiving a selection of a first one of the selectable juror icons;
displaying on the display screen questions asked of the prospective jurors in the courtroom and selectable answers to each of the questions, wherein various point values are associated with each of the selectable answers;
receiving a selection of a first one of the selectable answers while the first one of the selectable juror icons remains selected, wherein a first one of the various point values is associated with the first one of the selectable answers;
adding the first one of the various point values to a first running total of points;
displaying on the display screen the first running total of points in association with the first one of the selectable juror icons; and
displaying on the display screen a list of the prospective jurors in the courtroom corresponding to the selectable juror icons, wherein the list of the prospective jurors visually indicates which one of the prospective jurors is associated with the first one of the selectable juror icons selected, wherein the list, the questions, and the one or more selectable juror icons within the bounded area are displayed simultaneously on the display screen.

2. The computer-implemented method of claim 1, further comprising selecting an option on the display screen to purchase proprietary analytics from a menu of proprietary analytics options, wherein the questions displayed or the various point values associated with each of the selectable answers are automatically pre-set based on the purchased proprietary analytics.

3. The computer-implemented method of claim 1, further comprising:
receiving instructions to relocate the first one of the selectable juror icons within the bounded area; and
relocating the first one of the selectable juror icons within the bounded area in response to the instructions, wherein locations of each of the selectable juror icons within the bounded area represent corresponding locations of the prospective jurors in the courtroom.

4. The computer-implemented method of claim 1, further comprising:
receiving instructions to rotate the first one of the selectable juror icons; and
rotating the first one of the selectable juror icons in response to the instructions, wherein orientations of each of the selectable juror icons represent what direction the prospective jurors in the courtroom are facing.

5. The computer-implemented method of claim 1, further comprising:
receiving a selection of a second one of the selectable answers while none of the selectable juror icons are selected;
receiving selections of a second plurality of the selectable juror icons while the second one of the selectable answers remains selected; and
visually associating the second plurality of selectable juror icons with the second one of the selectable answers, indicating the ones of the prospective jurors in the courtroom who chose the second one of the selectable answers.

6. The computer-implemented method of claim 1, further comprising receiving instantaneous changes to the display screen from a plurality of external electronic devices over a communications network.

7. The computer-implemented method of claim 1, further comprising displaying a sentiment slider associated with each of the selectable juror icons and selectable to slide between a positive sentiment and a negative sentiment associated with each of the prospective jurors in the courtroom.

8. The computer-implemented method of claim 1, further comprising displaying a first selectable status indicator while the first one of the selectable juror icons remains selected, wherein the first selectable status indicator is associated with the first one of the prospective jurors in the courtroom, wherein the first selectable status indicator, the list, and the one or more selectable juror icons within the bounded area are displayed simultaneously on the display screen.

9. The computer-implemented method of claim 8, wherein, when selected, the first selectable status indicator visually indicates at least one of the following was requested or has been granted by a judge of the courtroom in regards to the first one of the prospective jurors in the courtroom: a peremptory strike, a for cause strike, excused by the court, and selected for jury.

10. The computer-implemented method of claim 1, further comprising visually indicating on at least some of the selectable juror icons requested or granted jury selection status for corresponding ones of the prospective jurors in the courtroom, wherein the requested or granted jury selection status is at least one of the following: a peremptory strike, a for cause strike, excused by the court, and selected for jury.

11. The computer-implemented method of claim 1, further comprising uploading biographical information regarding each of the prospective jurors from one or more sources, and automatically scoring or sorting into various categories the prospective jurors on the list of prospective jurors based on this biographical information.

12. The computer-implemented method of claim 1, wherein the list of the prospective jurors is re-orderable according to at least one of the following: answers to questions as recorded for each of the prospective jurors, selected locations of sentiment sliders associated with each of the selectable juror icons, assigned juror numbers, alphabetical order of prospective juror names, follow-up flags or categories selected for any of the prospective jurors, or a requested or granted jury selection status of each of the prospective jurors.

13. A non-transitory computer storage medium storing computer-useable instructions that, when used by one or more computing devices, cause the one or more computing devices to perform operations comprising:
displaying on a display screen of an electronic device a bounded area representing a courtroom and one or more selectable juror icons within the bounded area, wherein the selectable juror icons represent one or more prospective jurors in the courtroom;
receiving a selection of a first one of the selectable juror icons;
changing, in response to receiving the selection, a visual characteristic of the first one of the selectable juror icons to indicate that the first one of the selectable juror icons is selected;
receiving instructions to rotate the first one of the selectable juror icons and instructions to relocate the first one of the selectable juror icons;
rotating the first one of the selectable juror icons in response to the instructions to rotate thereby changing an orientation of the first one of the selectable juror icons, wherein the orientation of the first one of the selectable juror icons represents a direction that a first one of the prospective jurors in the courtroom is facing;
relocating the first one of the selectable juror icons within the bounded area in response to the instructions to relocate, wherein a location of the first one of the selectable juror icons represents a location of the first one of the prospective jurors in the courtroom;
displaying a first selectable status indicator while the first one of the selectable juror icons remains selected, wherein the first selectable status indicator is associated with the first one of the prospective jurors in the courtroom, wherein, when selected, the first selectable status indicator visually indicates at least one of the following was requested or has been granted by a judge of the courtroom in regards to the first one of the prospective jurors in the courtroom: a peremptory strike, a for cause strike, excused by the court, and selected for jury; and
receiving information regarding the prospective jurors in the courtroom; and
displaying a list of the prospective jurors in the courtroom corresponding to the selectable juror icons, wherein the list of the prospective jurors is selectably re-orderable based on the received information regarding the prospective jurors.

14. The non-transitory computer storage medium of claim 13, the operations further comprising:
displaying questions asked of the prospective jurors in the courtroom;
displaying selectable answers to each of the questions;
receiving various point values associated with at least some of the selectable answers;
receiving a selection of a first one of the selectable answers while the first one of the selectable juror icons remains selected, wherein a first one of the various point values is associated with the first one of the selectable answers; and
adding the first one of the various point values to a running total of points displayed in association with the first one of the selectable juror icons in response to receiving the selection of the first one of the selectable answers while the first one of the selectable juror icons remains selected.

15. The non-transitory computer storage medium of claim 13, the operations further comprising:
displaying questions asked of the prospective jurors in the courtroom;
displaying selectable answers to each of the questions;
receiving a selection of a first one of the selectable answers while none of the selectable juror icons are selected;
receiving selections of a first plurality of the selectable juror icons while the first one of the selectable answers remains selected; and
visually associating the first plurality of selectable juror icons with the first one of the selectable answers, indicating ones of the prospective jurors in the courtroom who chose the first one of the selectable answers.

16. The non-transitory computer storage medium of claim 13, further comprising receiving instantaneous changes to the display screen from a plurality of external electronic devices over a communications network.

17. The non-transitory computer storage medium of claim 13, further comprising displaying a sentiment slider associated with each of the selectable juror icons and selectable to slide between a positive sentiment and a negative sentiment associated with each of the prospective jurors in the courtroom.

18. The non-transitory computer storage medium of claim 13, wherein visually indicating the jury selection status further comprises visually indicating which side of a case requested the peremptory strike or the for cause strike.

19. A system for juror selection tracking and analysis, the system comprising:
at least one processor;
at least one data storage device communicably coupled with the at least one processor, wherein the data storage device comprises a non-transitory computer storage medium storing computer-useable instructions that, when used by the at least one processor, causes the at least one processor to perform operations comprising:
selecting an option, on a display screen of an electronic device, to purchase proprietary analytics from a menu of proprietary analytics options;
displaying on the display screen a bounded area representing a courtroom and one or more selectable juror icons within the bounded area, wherein the selectable juror icons represent one or more prospective jurors in the courtroom;
receiving a selection of a first one of the selectable juror icons;
changing, in response to receiving the selection, a visual characteristic of the first one of the selectable juror icons to indicate that the first one of the selectable juror icons is selected;
receiving instructions to rotate the first one of the selectable juror icons and instructions to relocate the first one of the selectable juror icons;
rotating the first one of the selectable juror icons in response to the instructions to rotate thereby changing an orientation of the first one of the selectable juror icons, wherein the orientation of the first one of the selectable juror icons represents a direction that a first one of the prospective jurors in the courtroom is facing;
relocating the first one of the selectable juror icons within the bounded area in response to the instructions to relocate, wherein a location of the first one of the selectable juror icons represents a location of the first one of the prospective jurors in the courtroom;
displaying questions asked of the prospective jurors in the courtroom;
displaying selectable answers to each of the questions, wherein various point values are associated with each of the selectable answers wherein the questions displayed or the various point values associated with each of the selectable answers are automatically pre-set based on the purchased proprietary analytics;
receiving a selection of a first one of the selectable answers while the first one of the selectable juror icons remains selected, indicating an answer provided by the first one of the prospective jurors in the courtroom;
adding a first one of the various point values associated with the first one of the selectable answers to a running total of points; and
displaying the running total of points in association with the first one of the selectable juror icons.

20. The system of claim 19, the operations further comprising:
displaying a first selectable status indicator while the first one of the selectable juror icons remains selected,
wherein the first selectable status indicator is associated with the first one of the prospective jurors in the courtroom,
wherein, when selected, the first selectable status indicator visually indicates at least one of the following was requested or has been granted by a judge of the courtroom in regards to the first one of the prospective jurors in the courtroom: a peremptory strike, a for cause strike, excused by the court, and selected for jury.
